(19) United States
(12) Patent Application Publication
(10) Pub. No.: US 2021/0396027 A1
(43) Pub. Date: Dec. 23, 2021

(54) PLASTER-BOX WITH IMPROVED HANDLE ATTACHMENT MECHANISM

(71) Applicant: Aaron Mark Roberts, Auckland (NZ)

(72) Inventor: Aaron Mark Roberts, Auckland (NZ)

(21) Appl. No.: 17/465,871

(22) Filed: Sep. 3, 2021

Related U.S. Application Data
(60) Provisional application No. 63/083,109, filed on Sep. 25, 2020.
(60) Provisional application No. 63/225,490, filed on Jul. 24, 2021.

(51) Int. Cl. E04F 21/08

(52) U.S. Cl. CPC E04F 21/08

(57) ABSTRACT

The present invention provides a plaster-box with improved handle attachment. The improved plaster-box is easy to operate and is user friendly. The plaster-box includes a handle attachment mechanism. The handle attachment mechanism removably couples a plaster-box handle to the top lid. The handle attachment mechanism includes a first clamp assembly and a second clamp assembly. The first clamp assembly includes a first screw member, a first clamp lever and a first clamping member. The second clamp assembly includes a second screw member, a second clamp lever and a second clamping member. The clamping force exerted by the first clamping member and the second clamping member tightens the handle with the top lid.

### CROSS-REFERENCE TO RELATED APPLICATIONS

This application claims the benefit of U.S. Provisional Application No. U.S. 63/083,109, filed on Sep. 25, 2020 and Provisional Application No. 63/225,490, filed on 24 Jul. 2021. The entire disclosure of the above applications is hereby incorporated herein by reference.

### FIELD OF THE INVENTION

The present invention relates to plaster boxes or flat box finishers, and more particularly pertains to an improved handle attachment mechanism for a plaster-box for providing a convenient and easy way of using the plaster-box.

### BACKGROUND

A plaster (e.g., mastic or joint compound) is a building material that is applied to walls and ceilings as a protective coating. A plaster-box or a flat box finisher is a device that discharges a plaster when pressed against a flat surface. The plaster-box is typically used for applying the plaster to flat seams/joins in a plaster board.

FIG. 1A and FIG. 1B shows perspective views of a known plaster box. FIG. 1A in particular shows the plaster box 1 with a plaster box handle 2 attached to it, whereas FIG. 1B shows just the plaster box 1. FIG. 1A and FIG. 1B shows wingnuts 3 that attaches the plaster-box 1 to the plaster box handle 2.

As well illustrated in FIGS. 1A and 1B, the plaster-box 1 includes a housing having a top, a bottom, a front, a back, a first side, a second side and an interior; a movable top lid substantially forming the top of the housing. The plaster-box 1 is hollow inside. The plaster-box 1 is filled with plaster. Further, the plaster box 1 includes a plaster dispensing mechanism for dispensing the plaster with same discharge rate. The plaster dispensing mechanism includes a hinged pressure plate 4 connected to the plaster-box 1. The pressure exerted by a user dispenses the plaster out through a slot configured in a faceplate of the plaster box. A troweling bar then spreads the plaster and causes a uniform thickness layer to be deposited on the surface such as a plasterboard surface.

The plaster box handle 2 is removably attached to the plaster-box 1. Presently, a variety of handles (with shorter or longer lengths) are available in the market based on the intended areas where the plaster-box 1 is supposed to be used.

As evident from FIGS. 1A and 1B, the plaster-box 1 is attached to the plaster box handle 2 by securing the two wingnuts 3 in the two holes configured on the top lid/pressure plate 4. The user needs to turn the wingnuts 3 so as to clamp the handle 2 and the plaster-box 1 together by using his/her hand. However, the wingnuts 3 tightened by hand strength alone can quite easily come loose. The wingnuts 3 failures can lead to fall of the plaster-box 1 causing injury to the user, and damage to the plaster-box itself and cause damage to the surrounding areas of the room. For overcoming this problem, the users can try hitting and fixing of the wingnuts 3 with a heavy handheld tools such as pliers. Although, this can help in tightening of the wingnuts 3 further, however such activity can damage the wingnuts 3.

Therefore, there is need for a plaster box handle attachment mechanism for attaching the plaster box handle to the plaster-box that would help overcome shortcomings associated with the wingnuts used in the prior plaster boxes such as one shown in FIG. 1A.

### BRIEF SUMMARY

The embodiments of the present invention provide a plaster box with a handle attachment mechanism. The plaster-box includes a movable top lid. The top lid includes a first hole and a second hole. The handle attachment mechanism removably couples the plaster-box handle to the top lid. The handle attachment mechanism includes a first clamp assembly and a second clamp assembly. The handle includes a coupling plate at one end. The first clamp assembly includes a first screw member, a first clamp lever and a first clamping member. The second clamp assembly includes a second screw member, a second clamp lever and a second clamping member.

Upon rotating the first clamp lever from a first operable position a first non-operable position, the first clamping member starts moving vertically downward along a first screw axis. The downward movement of the first clamping member generates a linear clamping force along the first screw axis. The clamping force exerted by the first clamping member tightens the handle with the top lid of the plaster-box. When the first clamp lever is operated to the first non-operable position, the first clamp lever gets locked by a friction of the first clamp lever against the first washer.

Similarly, upon rotating the second clamp lever from a second operable position to a second non-operable position, the second clamping member starts moving vertically downward along a second screw axis. The downward movement of the second clamping member generates a linear clamping force along the second screw axis. The clamping force exerted by the second clamping member tightens the handle with the top lid of the plaster-box. When the second clamp lever is operated to the second non-operable position, the second clamp lever gets locked by a friction of the second clamp lever against the second washer.

The plaster-box is made from polyurethane, polycarbonate, stainless steel, aluminum, ceramic, or any other variations known to a person skilled in the art. The manufacturing method of the plaster-box may include injection molding, rotational molding, compression molding, die casting, laser cutting, 3D printing, or any other variations known to a person skilled in the art. The present plaster-box has an advantage of securing a handle to the top lid as per requirement in the Drywall Industry. This is achieved by modifying the lid design of a plaster-box so that a screw member as a lever can be used instead of a wingnut to attach the handle to the plaster-box. The custom plaster-box assembly is economical. The handle attachment mechanism is user friendly.

These and other features and advantages of the present invention will become apparent from the detailed description below, in light of the accompanying drawings.

### BRIEF DESCRIPTION OF THE ACCOMPANYING DRAWINGS

In the drawings:

FIG. 1A-FIG. 1B shows perspective views of a known plaster box according to an existing prior art. FIG. 1A in particular shows the plaster box with a plaster box handle attached to it, whereas FIG. 1B shows just the plaster box.

FIG. 2 shows a side view of a plaster-box with a plaster box handle attachment mechanism of the present invention, in accordance with an embodiment of the present invention;

FIG. 3 shows an assembly of a plaster-box top lid with the plaster box handle attachment mechanism, in accordance with an embodiment of the present invention; and

FIGS. 4, 5, and 6 show exploded views of the plaster box handle attaching mechanism with respect to the plaster-box's top lid, in accordance with various embodiments of the present invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes an improved handle attachment mechanism for a plaster-box and/or an improved plaster-box. Accordingly, the components have been represented, showing only specific details that are pertinent for understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

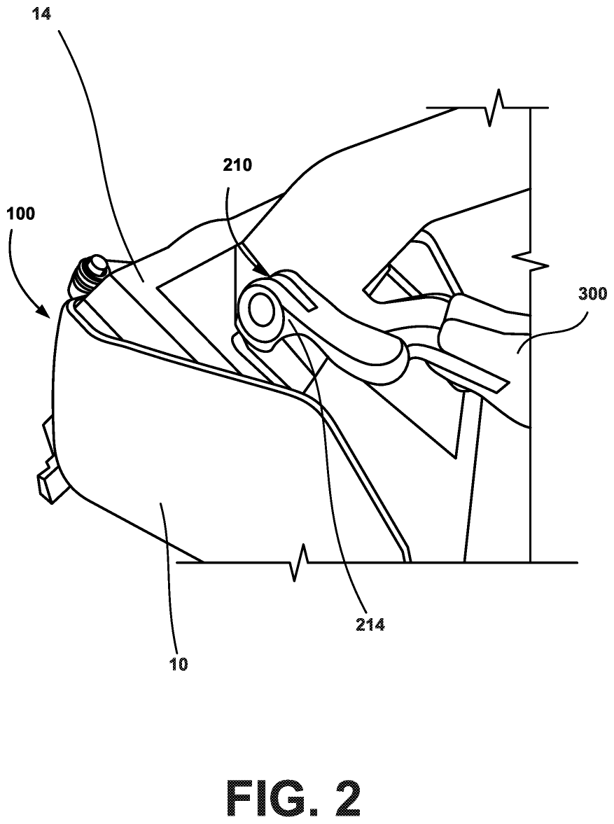

The plaster-box with improved plaster box handle attachment mechanism or assembly will now be described with reference to the accompanying drawings, particularly FIGS. 2-6, which should be regarded as merely illustrative without restricting the scope and ambit of the present invention.

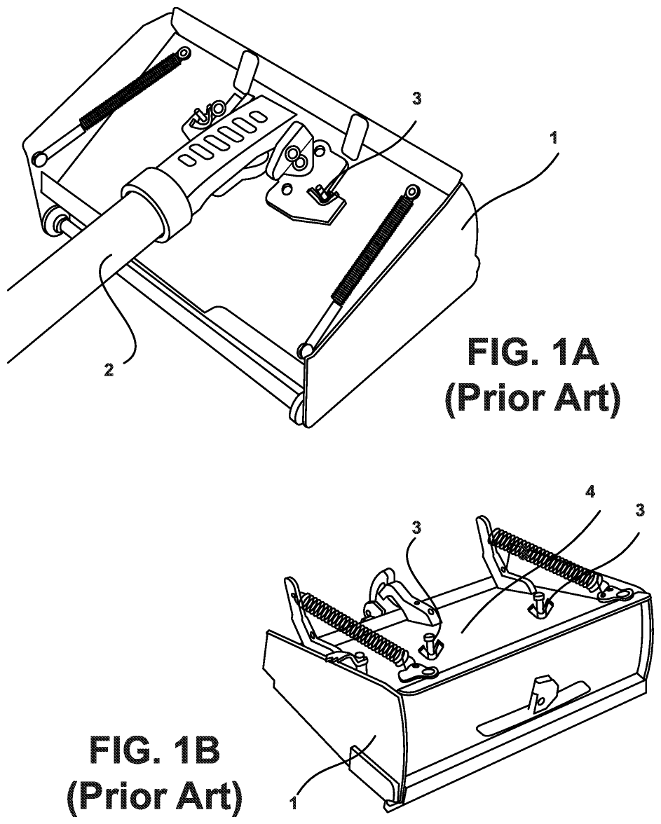

The present invention provides a plaster-box with a plaster box handle attachment mechanism for overcoming the problems existing with the prior art handle attachment mechanism (E.g., wingnuts) as described with respect to FIGS. 1A-1B.

FIG. 2 shows a side view of a plaster-box in accordance with an embodiment of the present invention. FIG. 2 is an illustration of the plaster-box 100 in a preferred embodiment of the present invention. FIG. 2 is a three-dimensional (3D) depiction of the plaster-box 100 that has been oriented to reveal the preferred embodiment of the present invention as it appears in a physical state. The plaster box 100 like any conventional plaster boxes or flat boxes comprises a housing 10 having a top, a bottom, a front, a back, a first side, a second side and an interior. The plaster box 100 further includes a movable top lid 14 substantially forming the top of the housing 10. Furthermore, the top lid 14 is rotatably attached to the plaster-box 100. The top lid 14 is rotatable about a lid pivot axis (not shown).

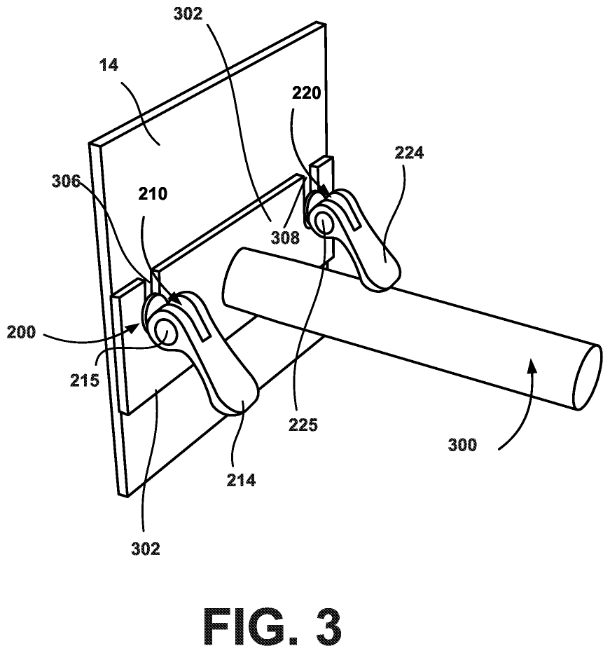

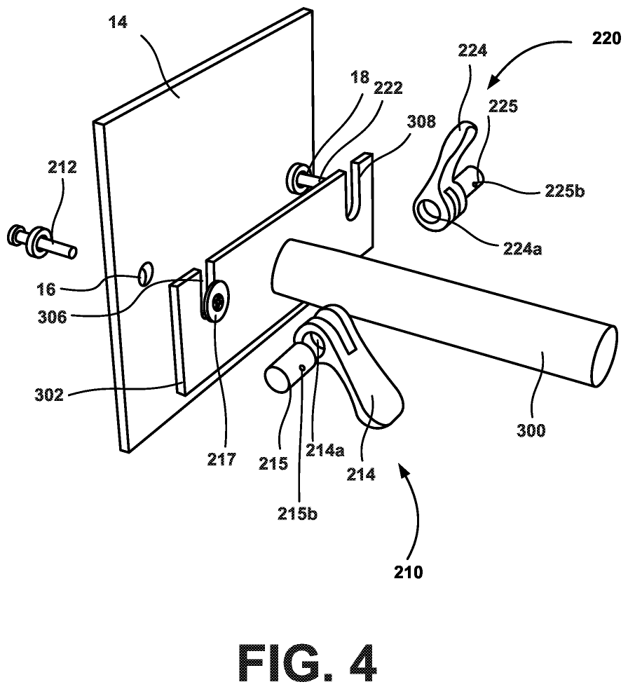

FIG. 3 shows an assembly of a top lid 14 and a plaster box handle attachment mechanism 200, in accordance with an embodiment of the present invention. In an exemplary embodiment, the top lid 14 includes a first hole 16 and a second hole 18 (shown in FIG. 4). The first hole 16 comprises a first inner thread configuration. The second hole 18 comprises a second inner thread configuration. The diameter of the first hole and the second hole are substantially same. The holes 16, 18 are spaced apart equally from a virtual centerline passing from the top lid 14 and through the center of a plaster-box handle 300.

Further, as illustrated in FIG. 3, the plaster-box 100 includes a handle attachment mechanism 200. The handle attachment mechanism 200 removably couples the plaster-box handle 300 to the top lid 14. The handle attachment mechanism 200 includes a first clamp assembly 210 and a second clamp assembly 220. The handle 300 includes a coupling plate 302 at one end. The coupling plate 302 further includes a first cut out region or a first slot 306 for enabling the handle's attachment to the top lid 14 using the first clamp assembly 210. Similarly, the coupling plate 302 further includes a second cut out region or a second slot 308 for enabling the handle's attachment to the top lid 14 using the second clamp assembly 220. According to the embodiment, total number of the slots formed on the plate is ideally equal to the total number of clamp assemblies being used to attach the handle 300 with the top lid 14.

FIG. 4 show an exploded view of a plaster box handle attachment mechanism 200 in accordance with the embodiment of the present invention. In FIG. 4, the first clamp assembly 210 is shown in detail.

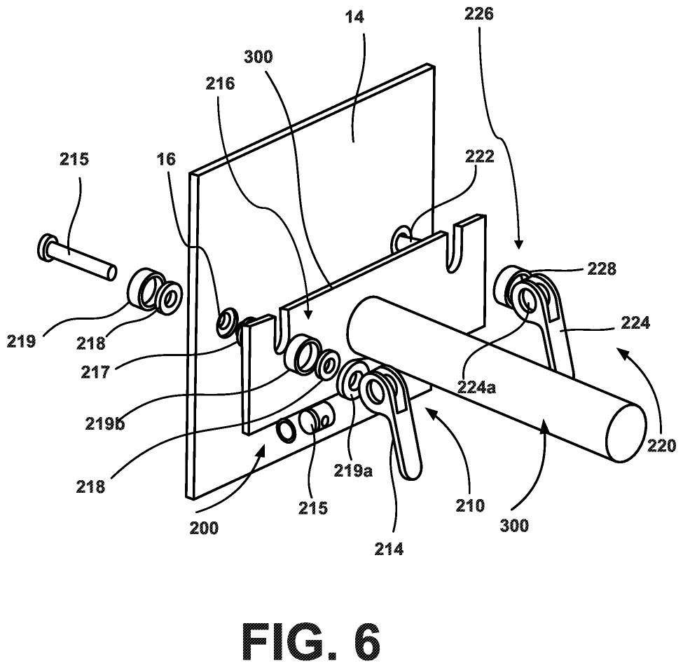

In one embodiment, the first clamp assembly 210 includes a first screw member 212, a first clamp lever 214 and a first clamping member 216 (seen in FIG. 6). The first clamp assembly 210 is mounted onto the top lid 14. The first screw member 212 is secured in the first hole 16. The first screw member 212 includes a first screw axis (not shown). The first screw member 212 is pivotally connected to the first clamp lever 214. Further, the first clamping member 216 includes a first washer 217, a first pair of opposing magnets 218 and a first pair of clamp spacers 219a, 219b as seen in FIG. 6. The first pair of opposing magnets 218 is secured in the first screw member 212 and between the first pair of clamp spacer 219a, 219b. The first washer 217 is secured in the first screw member 212 and between the first pair of opposing magnets 218. A first bottom clamp spacer 219a is having threads configured thereon. Generally, the first bottom clamp spacer 219a is positioned below the top lid 14.

The first washer 217 is held up off the top lid 14 for ease of handle 300 insertion by the pair of first opposing magnets 218 with the first pair of the clamp spacers 219a, 219b.

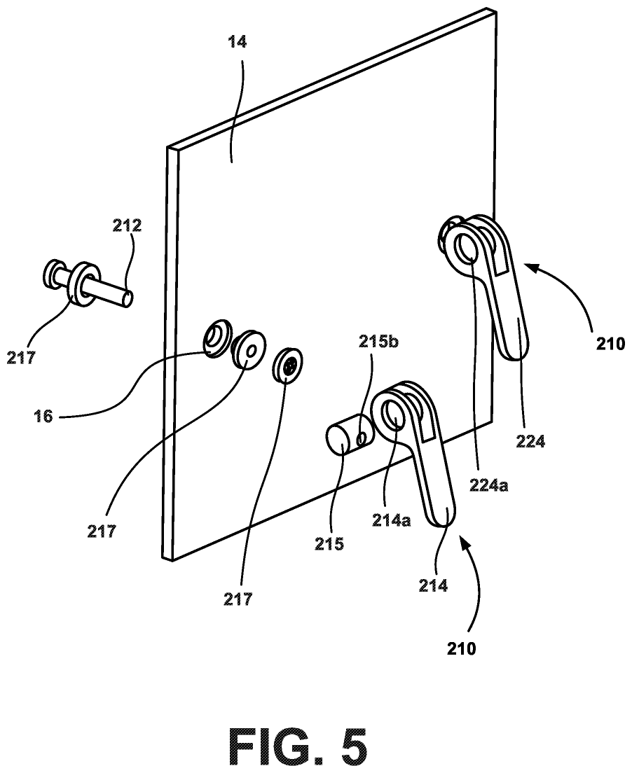

FIG. 5 shows perspective exploded view of the handle attaching mechanism 200 in accordance with the embodiment of the present invention. In an exemplary embodiment of the present invention, the first clamp assembly 210 is shown in detail. Similar to FIG. 4, FIG. 5 illustrates the assembly of the top lid 14 with a handle attachment mechanism 200.

Further, in one embodiment, the first clamp lever 214 includes a first cavity 214a for securing the first pivot pin 215 therein. The first pivot pin 215 is having a first magnetic ring. Further, the first pivot pin 215 is having a first pivot hole 215b. The first screw member 212 is secured in the first pivot hole 215b. The first pivot pin 215 is having a first pivotal axis. The first pivotal axis of the first pivot pin 215 is perpendicular to the first screw axis. The first clamp lever 214 is rotatable about the first pivotal axis. In one embodiment, the first clamp lever 214 is rotatable between a first operable position to a first non-operable position. More specifically, the first clamp lever 214 operates the first clamping member 216 secured in the first screw member 212 so as to facilitate the tightening or engagement of the plaster-box handle 300 with the top lid 14. The first operable position is an unlocked position of the first clamp lever 214 and the first clamp lever 214 is free to rotate along the first pivot axis. The first non-operable position is a locked position of the first clamp lever 214 where a rotational motion of the first clamp lever 214 is restricted. The angle between the first operable position and the first non-operable position defines the total rotation for the first clamp lever 214 in both clockwise and anticlockwise direction.

Furthermore, in preferred embodiment, the second clamp assembly 220 includes a second screw member 222, a second clamp lever 224 and a second clamping member 226. The second clamp assembly 220 is mounted to the top lid 14. The second screw member 222 is secured in the second hole 18. The second screw member 222 is having a second screw axis (not shown). The second screw member 222 is pivotally connected to the second clamp lever 224. Further, the second clamping member 226 includes a second washer (not shown), a second pair of opposing magnets (not shown) and a second pair of clamp spacers (not shown). The second pair of opposing magnets is secured in the second screw member 222 and between the second pair of clamp spacers. The second washer is secured in the second screw member 222 and between the second pair of opposing magnets. Generally, a second bottom clamp spacer (not shown) is having threads configured thereon.

The second washer is held up off the top lid 14 for ease of handle 300 insertion by the pair of the second pair of opposing magnets with the second pair of clamp spacers.

The second clamp lever 224 is having a second cavity 224a for securing the second pivot pin 225 therein. The second pivot pin 225 is having a second pivot hole 225b. The second pivot pin 225 is having a second magnetic ring. The second screw member 222 is secured in the second pivot hole 225b. The second pivot pin 225 is having a second pivotal axis. The second pivotal axis of the second pivot pin 225 is perpendicular to the second screw axis. The second clamp lever 224 is rotatable about the second pivotal axis of the second pivot pin 225. The second clamp lever 224 is rotatable between a second operable position to a second non-operable position. The second clamp lever 224 operates the second clamping member 226 secured in the second screw 222 so as to facilitate the tightening or engagement of the plaster-box handle 300 with the top lid 14. The second operable position is an unlocked position of the second clamp lever 224 and the second clamp lever 224 is free to rotate along the second pivot axis. The second non-operable position is a locked position of the second clamp lever 224 and a rotational motion of the second clamp lever 224 is restricted. The angle between the second operable position and the second non-operable position defines the total rotation for the second clamp lever 224 in both clockwise and anticlockwise direction. Lots of parts/components of the second clamp assembly 220 are not visible in the figure, it should be understood that the second claim assembly and parts associated thereof are similar to the first clamp assembly 210 discussed above.

FIG. 6 shows perspective exploded view of the handle attaching mechanism 200 in accordance with the embodiment of the present invention. In an exemplary embodiment of the present invention, the first clamping member 216 is shown in detail. Similar to FIG. 4 and FIG. 5, FIG. 6 illustrates the assembly of a top lid 14 with a handle attachment mechanism 200.

Initially, the first clamp lever 214 and the second clamp lever 224 are at the first and the second operable positions respectively. The first clamp assembly 210 and the second clamp assembly 220 are enabled to receive the handle 300. The handle 300 is received over the top lid 14, around the first screw member 212 and the second screw member 214 and beneath the first clamping member 216 and the second clamping member 226 respectively.

Upon rotating the first clamp lever 214 from the first operable position to the first non-operable position, the first clamping member 216 starts moving vertically downward along the first screw axis. The downward movement of the first clamping member 216 generates a linear clamping force along the first screw axis. The clamping force exerted by the first clamping member 216 tightens the handle 300 with the top lid 14 of the plaster-box 100. When the first clamp lever 214 is operated to the first non-operable position, the first clamp lever 214 gets locked by a friction of the first clamp lever 214 against the first washer 217.

Similarly, upon rotating the second clamp lever 224 from the second operable position to second non-operable position, the second clamping member 226 starts moving vertically downward along the second screw axis. The downward movement of the second clamping member 226 generates a linear clamping force along the second screw axis. The clamping force exerted by the second clamping member 226 tightens the handle 300 with the top lid 14 of the plaster-box 100. When the second clamp lever 224 is operated to the second non-operable position, the second clamp lever 224 gets locked by a friction of the second clamp lever 222 against the second washer.

Upon rotating the first clamp lever 214 from the first non-operable position to the first operable position, the first clamping member 216 starts moving vertically upward along the first screw axis. The upward movement of the first clamping member 216 releases a linear clamping force acting on the handle 300 along the first screw axis. The clamping force released by the first clamping member 216 loosens the handle 300 with the top lid 14 of the plaster-box 100. Therefore, the handle 300 is enabled to remove from the first clamp 210 and ready to replace with new or another handle.

Similarly, upon rotating the second clamp lever 224 from the second non-operable position to second operable position, the second clamping member 226 starts moving vertically upward along the second screw axis. The upward movement of the second clamping member 226 releases a linear clamping force acting on the handle 300 along the second screw axis. The clamping force released by the second clamping member 226 loosens the handle 300 with the top lid 14 of the plaster-box 100. Therefore, the handle 300 is enabled to remove from the second clamp 220 and ready to replace with new or another handle.

Further, in one more embodiments, a first biasing member (not shown) and a second biasing member (not shown) may be configured with the first clamp assembly 210 and the second clamp assembly 220 respectively for biasing the clamping operations in vertical direction.

The plaster-box 100 is made preferably from polyurethane, polycarbonate, stainless steel, aluminum, ceramic, or any other variations known to a person skilled in the art. The manufacturing method of the plaster-box 100 may include injection molding, rotational molding, compression molding, die casting, laser cutting, 3D printing, or any other variations known to a person skilled in the art.

The present plaster-box 100 has an advantage of securing the handle 300 to the top lid 14 as per requirement in the Drywall Industry. This is achieved by modifying the lid 14 design of the plaster-box 100 so that the screw member 212, 222 as a lever can be used instead of wingnuts to attach the handle 300.

Although particular embodiments of the invention have been described in detail for purposes of illustration, various modifications and enhancements may be made without departing from the spirit and scope of the invention.

What is claimed is:

1. A plaster box (100), comprising:
a housing (10) having a top, a bottom, a front, a back, a first side, a second side and an interior; a movable top lid (14) substantially forming the top of the housing (10), wherein the top lid (14) comprises: a first hole (16); and a second hole (18); and
a plaster box handle attachment mechanism (200) for removably coupling a plaster-box handle (300) to the top lid (14), wherein the plaster box handle attachment mechanism (200) comprises: a first clamp assembly (210) mounted onto the top lid (14) by securing a first screw member (212) in the first hole (16), and a second clamp assembly (220) mounted to the top lid (14) by securing a second screw member (222) in the second hole (18).

2. The plaster-box (100) of claim 1, wherein the first hole (16) and the second hold (18) comprising a first inner thread configuration, and a second inner thread configuration respectively.

3. The plaster-box (100) of claim 1, wherein the first screw member (212) is pivotally connected to a first clamp lever (214) about a first pivotal axis of a first pivot pin (215) for operating a first clamping members (216) secured in the first screw member (212) so as to facilitate engagement and tightening of the plaster-box handle (300) with the top lid (14) by rotating the first clamp lever (214) from a first operable position to a first non-operable position.

4. The plaster-box (100) of claim 1, wherein the second screw member (222) is pivotally connected to a second clamp lever (224) about a second pivotal axis of a second pivot pin (225) for operating a second clamping member (226) secured in the second screw member (222) so as to facilitate engagement and tightening of the plaster-box handle (300) with the top lid (14) by rotating the second clamp lever (224) from a second operable position to a second non-operable position.

5. The plaster-box (100) of claim 3, wherein the first clamp lever (214) having a first cavity (214a) for securing the first pivot pin (215) therein.

6. The plaster-box (100) of claim 3, wherein the first screw member (212) is secured in a first pivot hole (215b) of the first pivot pin (215).

7. The plaster-box (100) of claim 3, wherein the first pivotal axis of the first pivot pin (215) is perpendicular to a first screw axis of the first screw member (212).

8. The plaster-box (100) of claim 4, wherein the second clamp lever (224) having a second cavity (224a) for securing the second pivot pin (225) therein.

9. The plaster-box (100) of claim 4, wherein the second screw member (222) is secured in a second pivot hole (225b) of the second pivot pin (225).

10. The plaster-box (100) of claim 4, wherein the second pivot axis of the second pivot pin (225) is perpendicular to a second screw axis of the second screw member (222).

11. The plaster-box (100) of claim 3, wherein the first clamping member (216) comprising a first washer (217) secured between a first pair of opposing magnets (218) and between a first pair of clamp spacers (219a,219b) in the first screw member (212).

12. The plaster-box (100) of claim 11, wherein a first bottom clamp spacer (219a) of the first pair of clamp spacers (219a,219b) is having threads configured thereon.

13. The plaster-box (100) of claim 4, wherein the second clamping member (226) comprising a second washer secured between a second pair of opposing magnets and between a second pair of clamp spacers in the second screw member (222).

14. The plaster-box (100) of claim 13, wherein a second bottom clamp spacer of the second pair of clamp spacers is having threads configured thereon.

15. The plaster-box (100) of claim 3, wherein the first clamp lever (214) at the first operable position enables the first clamp assembly (210) to receive a coupling plate (302) of the handle (300) on the top lid (14), around the first screw member (212) and beneath the first clamping member (216).

16. The plaster-box (100) of claim 4, wherein the second clamp lever (224) at the second operable position enables the second clamp assembly (220) to receive the coupling plate (302) of the handle (300) on the top lid (14), around the second screw member (222) and beneath the second clamping member (226).

17. The plaster-box (100) of claim 3, wherein upon rotating the first clamp lever (212) from the first operable position to the first non-operable position, the first clamping member (216) starts moving vertically downward with a clamping force along the first screw axis for tightening the coupling plate (302) with the top lid (14) of the plaster-box (100).

18. The plaster-box (100) of claim 4, wherein upon rotating the second clamp lever (222) from the second operable position to the second non-operable position, the second clamping member (226) start moving vertically downward with a clamping force along the second screw axis for tightening the coupling plate (302) with the top lid (14) of the plaster-box (100).

19. The plaster-box (100) of claim 3, wherein the first clamp lever (212) is locked by a friction of the first clamp lever (212) against the first washer (217) at the first non-operable position, thereby assuring the clamping force on the handle (300) for a required time.

20. The plaster-box (100) of claim 4, wherein, the second clamp lever (222) is locked by a friction of the second clamp lever (222) against the second washer at the second non-operable position; thereby assuring the clamping force on the handle (300) for a required time.
